(19) United States
(12) Patent Application Publication
(10) Pub. No.: US 2010/0028186 A1
(43) Pub. Date: Feb. 4, 2010

(54) HYDRAULIC MACHINE

(75) Inventors: Niels E. Sevelsted, Nordborg (DK); Hans Christian Petersen, Nordborg (DK)

Correspondence Address: MCCORMICK, PAULDING & HUBER LLP, CITY PLACE II, 185 ASYLUM STREET, HARTFORD, CT, 06103, US

(73) Assignee: SAUER-DANFOSS APS, Nordborg (DK)

(21) Appl. No.: 12/444,012

(22) PCT Filed: Oct. 4, 2007
(86) PCT No.: PCT/DK2007/000428

§ 371 Date: Jun. 30, 2009

(30) Foreign Application Priority Data
Oct. 6, 2006 (DE) 10 2006 047 312.4

(51) Int. Cl. F03C 2/08; F01C 1/10; F01C 21/08; B23P 15/14

(52) U.S. Cl. 418/61.3; 29/893.3

(57) ABSTRACT

A hydraulic machine is disclosed with an externally toothed gear wheel (3) and an internally toothed ring, the gear wheel (3) and the ring together forming pressure pockets, which expand and compress during operation, the gear wheel (3) having recesses (22-25), which form part of a secondary control system. The machine should be designed to operate in a simple manner with little wear. To achieve this, the gear wheel (3) is made as a sintered element, in which the recesses (22-25) are sintered.

### CROSS REFERENCE TO RELATED APPLICATION

This application is entitled to the benefit of and incorporates by reference essential subject matter disclosed in International Patent Application No. PCT/DK2007/000428 filed on Oct. 4, 2007 and German Patent Application No. 10 2006 047 312.4 filed Oct. 6, 2006.

### FIELD OF THE INVENTION

The invention concerns a hydraulic machine with an externally toothed gear wheel and an internally toothed ring, the gear wheel and the toothed ring forming pressure pockets between them, which increase and decrease their size during operation, the gear wheel comprising recesses forming parts of a secondary control.

### BACKGROUND OF THE INVENTION

Such a hydraulic machine is, for example, known from DE 102 09 672 B3. When a pressure chamber has its largest or its smallest volume, the recesses form a short circuit with the neighbouring pressure chamber. Thus, it is possible to avoid pressure peaks in the pressure chambers, which could have a negative effect on the life of the machine.

DE 102 00 968 C1 shows a hydraulic motor, in which also a secondary commutation or a secondary control is provided. In one of its front sides, the gear wheel has pockets, which interact with a motor element arranged next to the gear arrangement of gear wheel and toothed ring. Also here, pressure peaks are avoided, which could occur, if a pressure pocket had its smallest or largest volume, and the allocated valve could not yet provide the corresponding pressure control because of an inaccurate manufacturing or a non-avoidable play.

This so-called secondary commutation has proved its worth in several hydraulic machines. However, it requires a relatively accurate manufacturing. After manufacturing the gear wheel, which is in itself already relatively complicated, as a tool has to follow certain curves, the gear wheel must be inserted in a further machine tools, for example a milling machine, to manufacture the recesses. Chucking errors or other inaccuracies can practically not be avoided with reasonable efforts. If the recesses forming the secondary commutation are not exactly positioned, they cannot avoid the pressure peaks with the required reliability. This problem can be avoided in that the recesses are made so large that they can also avoid the pressure peaks, if the recesses are not exactly positioned. As, however, this causes a certain internal leakage, this solution is only chosen with some hesitation.

### BRIEF SUMMARY OF THE INVENTION

The invention is based on the task of providing low-wear operation behaviour in a simple manner.

With a hydraulic machine as mentioned in the introduction, this task is solved in that the gear wheel is made as a sintered element with sintered recesses.

By means of a sintering process, components can be made with a relatively high accuracy. In this connection, the mould used for the sintering merely has to have the desired accuracy. Accordingly, the manufacturing of the gear wheel, which is possible with a high accuracy, is simplified, as no or only a few additional machining processes are required. Further, the sintered recesses can, with practically no additional efforts, be made during the manufacturing of the gear wheel. For this purpose, the mould used for the sintering must merely be provided with corresponding projections. Thus, no further working steps are required for manufacturing these recesses. This also has the advantage that a sequence of working steps will not cause the occurrence of further errors. In particular, no chicking errors can occur, which could change the position of the recesses. The position of the recesses is thus very strictly fixed by the manufacturing in a sintering process. Accordingly, the secondary commutation during operation can be achieved very accurately, and thus large inner leakages can be avoided.

Preferably, the gear wheel has a sintered surface that extends into the recesses. When the gear wheel is removed from the mould used for the sintering, it is finished with the recesses. A further working, for example grinding, milling or machining, is not required. This has large advantages, not only during manufacturing, but also during operation, as the surface quality achieved in the recesses during sintering is sufficient to provide satisfactory operation behaviour.

Preferably, the recesses start from at least one front side of the gear wheel. This simplifies the manufacturing. A mould can be used, from which the gear wheel can be removed with a straight movement. No movable elements of the mould are required to generate the recesses.

Preferably, the recesses have walls, which extend in parallel to the axis of the gear wheel. Also this simplifies the manufacturing of the gear wheel. The gear wheel can be removed from the mould used for the sintering with an axis parallel movement.

Preferably, the recesses open in the direction of the circumferential face of the gear wheel. Thus, the secondary commutation happens between the gear wheel and the toothed ring.

Preferably, recesses are arranged on both front sides. Thus, it can be ensured that, during the secondary commutation, the forces acting upon the gear wheel are equalising each other at both axial ends of the gear wheel. Tilting moments between the gear wheel and the toothed ring, which could cause a wear, are avoided.

Preferably, the gear wheel has an inner toothing, which is made of sintering material. Thus, the toothing is also made during the manufacturing of the gear wheel. This further simplifies the manufacturing process. The toothing can be made with a relatively high accuracy, so that eventually a play between the inner toothing and an outer toothing on an engaging shaft can be kept small.

The invention also concerns a method for manufacturing a gear wheel of a hydraulic machine with recesses forming part of a secondary control, in which the gear wheel is made by sintering, and the recesses are made during the sintering.

As mentioned above in connection with the hydraulic machine, it is possible to make the gear wheel with a relatively large accuracy by means of a sintering process. At the same time, the recesses in the gear wheel can already be made so that the recesses can be positioned in the gear wheel with a high accuracy, without requiring further working steps. Thus, the risk of rechucking or chucking errors is avoided.

Preferably, the recesses are made in at least one front side. This simplifies the shaping. Then, the gear wheel can be removed from the mould used for the sintering with an axis parallel movement.

It is also advantageous to extend the recesses up to the circumferential face. Also this makes the construction of the mould used for the sintering relatively simple. The projections used to manufacture the recesses can be supported on two sides.

The invention also concerns a gear wheel for a hydraulic machine, which has recesses that form parts of a secondary control of the hydraulic machine, the gear wheel being a sintered element and the recesses being sintered.

### BRIEF SUMMARY OF THE DRAWINGS

In the following, the invention is described in detail on the basis of a preferred embodiment in connection with the drawings, showing:

FIG. 1 is a longitudinal section through a hydraulic machine,

FIG. 2 is a section II-II according to FIG. 1,

FIG. 3 is a perspective view of a gear wheel, and

FIG. 4 is a perspective view of the gear wheel according to FIG. 3 from a different view angle.

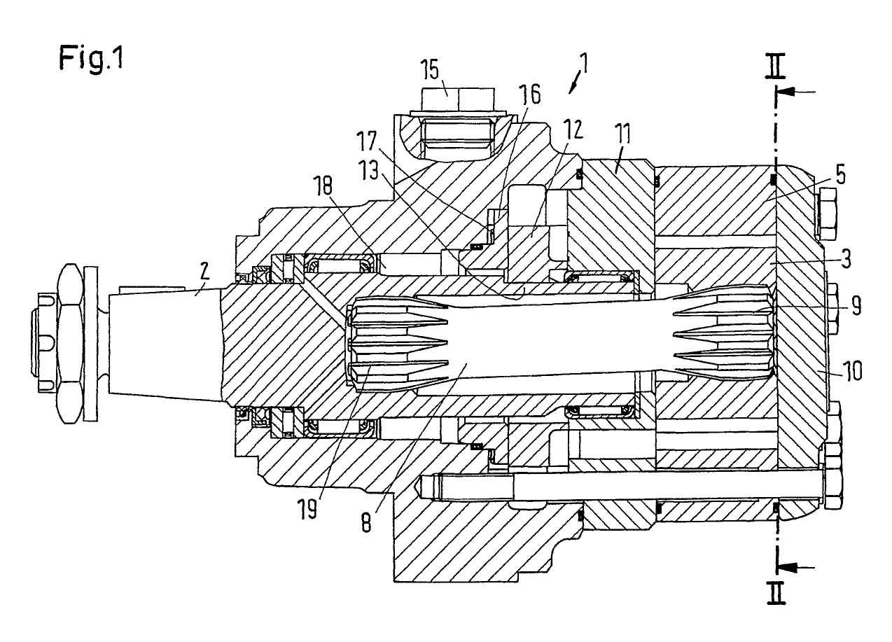

### DETAILED DESCRIPTION OF THE PREFERRED EMBODIMENTS

In the following, the invention will be described on the basis of a hydraulic machine in the form of a motor 1. Usually, such a machine can also be used as a pump.

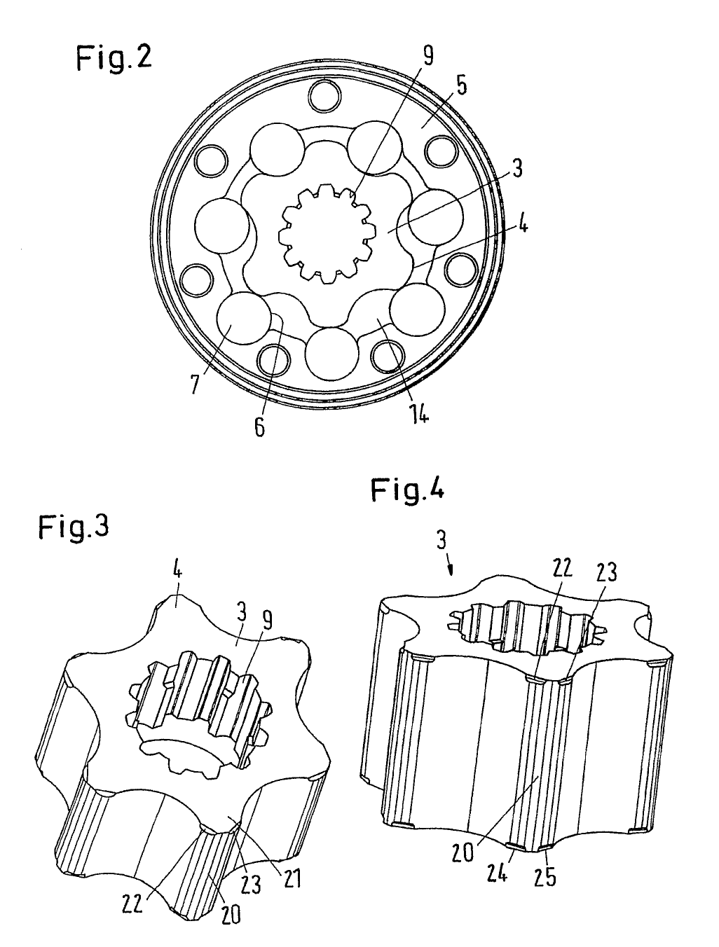

The motor 1 has an output shaft 2, which is driven by a gear wheel 3 that comprises an outer toothing 4 (FIG. 2). The gear wheel rotates and orbits in a toothed ring 5 that comprises an inner toothing 6, which is formed by rolls 7. The output shaft 2 is connected to the gear wheel 3 via a cardan shaft 8, which is inserted in a suitable toothing 9 inside the gear wheel 3.

On one side, the cardan shaft 8 projects over the gear wheel 3. On the opposite side a cover plate 10 is arranged, which covers the gear wheel 3 and the toothed ring. The cardan shaft extends through a channel plate 11, which interacts with a valve plate 12. The valve plate 12 engages an extension 13 of the output shaft 2, so that the valve plate 12 rotates synchronously with and in a predetermined angle relation to the gear wheel 3.

Together, the channel plate 11 and the valve plate 12 form a valve arrangement, which controls the supply of pressure chambers 14, which are formed between the inner toothing 6 of the toothed ring 5 and the outer toothing 4 of the gear wheel 3. The supply with hydraulic fluid occurs via a connection arrangement 15, which comprises a high-pressure connection and a low-pressure connection, not shown in detail.

A balancing plate 16 ensures tightness between the valve plate 12 and the channel plate 11. In this connection, the balancing plate 16 is loaded by a pressure spring 17 in the direction of the valve plate 12. Additionally, during operation, the pressure in a pressure chamber 18 acts upon the valve plate 12.

The cardan shaft 8 is connected to the output shaft 2 through a toothing 19. Neither this toothing 19, nor the toothing 9, via which the cardan shaft 8 is connected to the gear wheel 3, can be made completely without play. It is also possible that the cardan shaft 8 gets twisted in connection with large loads. The sum of the tolerances and errors may now cause the valve plate 12 to no longer ensure the control of the pressure chambers 14, as would usually be required. This is particularly critical, if the volume of a pressure chamber 14 has reached its maximum value and starts decreasing. If, at this moment, the hydraulic fluid cannot yet flow off, as the valve plate 12 has not released a corresponding path, pressure surges occur, which have a negative effect on the operation behaviour of the machine. The same problem occurs, if the volume of the pressure chamber 14 has passed through a minimum value and starts expanding. If this pressure chamber then has not yet received hydraulic fluid, cavitation problems may occur.

It is therefore known to provide a so-called secondary commutation or “secondary control”, which generates a short-circuit with the neighbouring pressure chamber at the times, when a pressure chamber has a minimum or maximum volume. This short-circuit provides a throttled balancing of the pressure, so that pressure peaks of positive or negative kind can be reduced.

FIG. 3 now shows the gear wheel 3 with outer toothing 4, in which the teeth 20 are provided with recesses 22-25 in the area of their tooth tips and in the area of the two front sides 21. Here, the recesses are arranged on both sides of a peak of the individual tooth 20.

The gear wheel 3 itself is made as a sintered element, that is, it is made during a sintering process. To put it simply, a sintering process involves that a metal powder is put into a mould and pressurised and heated. With such a sintering process, sintered parts can be made with a very high accuracy. The accuracy is so high that the gear wheel 3 needs no further working.

During this sintering process, additional elements of the gear wheel 3 can be manufactured, for example, the recesses 22-25. Also the toothing 9 can be made during this sintering process. For this purpose, it is sufficient to provide the inside of the mould used for sintering the gear wheel 3 with corresponding projections in the positions, in which the recesses 22-25 shall eventually be arranged. These projections can be supported on two walls of the mould, namely on the wall, which will eventually specify the front side 21 and on the wall, which forms the circumferential face of the gear wheel 3.

The side walls of the recesses 22-25 extend in parallel to the axis of the gear wheel 3, so that the gear wheel 3 can be removed from the sintering mould in parallel to its axis. Thus, the sintering mould can be made in a relatively easy manner.

Also here, the selection of the cross-sectional shape of the recesses 22-25 is relatively free. The cross-section must not necessarily be square. Also a rounded or curved bottom of the recesses 22-25 is possible.

The recesses 22-25 can be positioned with exactly the same accuracy, with which also the gear wheel 3 can be manufactured in the sintering process. Errors, which could occur by suspending the gear wheel 3 for a working, during which the recesses were previously made, are completely avoided. Accordingly, the accuracy, with which the secondary commutation occurs during operation, can be improved. This again causes that the flow cross-section, which is released by the recesses 22-25 can be reduced to a minimum. This again has positive effects on the inner leakage of the machine.

The embodiment described here, shows a motor 1 as a hydraulic machine. The term “hydraulic machine”, however, also comprises all other arrangements, in which a gear wheel is used to pressurise hydraulic fluid, or pressurised hydraulic fluid is used to move a gear wheel. Due to this, also a hydraulic steering unit is to be regarded as a hydraulic machine.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A hydraulic machine comprising an externally toothed gear wheel and an internally toothed ring, the gear wheel and the toothed ring forming pressure pockets with each other, said pressure pockets (14) expanding and contracting during operation, the gear wheel having recesses which form part of a secondary control, wherein the gear wheel is made as a sintered element with sintered recesses.

2. The machine according to claim 1, wherein the gear wheel has a sintered surface, which extends into the recesses.

3. The machine according to claim 1, wherein the recesses extend from at least one front side of the gear wheel.

4. The machine according to claim 1, wherein the recesses have walls, which extend in parallel to the axis of the gear wheel.

5. The machine according to claim 1, wherein the recesses open in the direction of the circumferential face of the gear wheel.

6. The machine according to claim 5, wherein recesses are arranged at both front sides.

7. The machine according to claim 1, wherein the gear wheel has an inner toothing, which is made of a sintering material.

8. A method for manufacturing a gear wheel of a hydraulic machine with recesses forming part of a secondary control, wherein the gear wheel is made by sintering, the recesses being formed during the sintering.

9. The method according to claim 8, wherein the recesses are made in at least one front side.

10. The method according to claim 8, wherein the recesses are led up to the circumferential face.

11. A gear wheel for a hydraulic machine, the gear wheel comprising recesses, which are part of a secondary control of the hydraulic machine, wherein the gear wheel is made as a sintered element, and the recesses are made during the sintering.
